(19) United States
(12) Patent Application Publication
(10) Pub. No.: US 2026/0142373 A1
(43) Pub. Date: May 21, 2026

(54) ELECTRONIC DEVICE

(71) Applicant: PEGATRON CORPORATION, TAIPEI CITY (TW)

(72) Inventors: Chia-Hung Chen, Taipei City (TW); Chi-Yin Fang, Taipei City (TW); Chao-Hsu Wu, Taipei City (TW); Chih-Wei Liao, Taipei City (TW); Hau Yuen Tan, Taipei City (TW); Shih-Keng Huang, Taipei City (TW); Cheng-Hsiung Wu, Taipei City (TW)

(73) Assignee: PEGATRON CORPORATION, TAIPEI CITY (TW)

(21) Appl. No.: 19/319,635

(22) Filed: Sep. 4, 2025

(30) Foreign Application Priority Data
Nov. 21, 2024 (TW) 113144907

(51) Int. Cl. H01Q 5/20; H01Q 1/22; H01Q 7/00

(52) U.S. Cl. CPC H01Q 5/20; H01Q 1/22; H01Q 7/00

(57) ABSTRACT

An electronic device includes a ground plane and an antenna module including first to fourth radiators and first to fifth electronic components. The first electronic component is coupled to a feed end and the ground plane. The second electronic component is coupled to the first and second radiators. The third electronic component is coupled to the second radiator and the ground plane. The first electronic component, the first radiator, the second electronic component, the second radiator, and the third electronic component form a first loop. The third radiator is coupled to the first radiator. The fourth electronic component is coupled to the third radiator and the ground plane. The first electronic component, the first, third radiators, and the fourth electronic component form a second loop. The fourth radiator is coupled to the feed end. The fifth electronic component is coupled to the fourth radiator and the ground plane.

### CROSS-REFERENCE TO RELATED APPLICATION

This application claims the priority benefit of Taiwan application serial no. 113144907, filed on Nov. 21, 2024. The entirety of the above-mentioned patent application is hereby incorporated by reference herein and made a part of this specification.

### BACKGROUND

### Technical Field

The disclosure relates to an electronic device, and in particular to an electronic device having an antenna module with multiple loops and multiple frequency bands.

Related Art

As technology advances, it is common to use an antenna to transmit and receive wireless signals. How to provide the antenna with multiple frequency bands is a research direction in this art.

### SUMMARY

The disclosure provides an electronic device having an antenna module with multiple loops and multiple frequency bands.

An electronic device of the disclosure includes a ground plane and an antenna module. The ground plane has a recess. The antenna module is disposed within the recess and includes a first radiator, a first electronic component, a second radiator, a second electronic component, a third electronic component, a third radiator, a fourth electronic component, a fourth radiator, and a fifth electronic component. The first radiator includes a feed end. The first electronic component is coupled to the feed end and the ground plane. The second electronic component is coupled to the first radiator and the second radiator. The third electronic component is coupled to the second radiator and the ground plane. The first electronic component, the first radiator, the second electronic component, the second radiator, and the third electronic component form a first loop. The first loop resonates at a first frequency band. The third radiator is coupled to the first radiator. The fourth electronic component is coupled to the third radiator and the ground plane. The first electronic component, the first radiator, the third radiator, and the fourth electronic component form a second loop. The second loop resonates at a second frequency band. The fourth radiator is coupled to the feed end. The fifth electronic component is coupled to the fourth radiator and the ground plane. The first electronic component, the feed end, the fourth radiator, and the fifth electronic component form a third loop. The third loop resonates at a third frequency band.

In an embodiment of the disclosure, the recess includes a first edge, a second edge, and a third edge. The first electronic component is coupled to the second edge. The first edge is closer to the first electronic component than the third edge.

In an embodiment of the disclosure, a first position and a second position are on the second edge. The first position is coupled to the first edge. The second position is coupled to the third edge. A distance between the first electronic component and the first position is 0.4 to 0.6 times a distance between the first electronic component and the second position.

In an embodiment of the disclosure, the third electronic component is coupled to the third edge. The fourth electronic component is coupled to the first edge. The fifth electronic component is coupled to the second edge.

In an embodiment of the disclosure, a length of the first loop is ⅛ wavelength of the first frequency band. A length of the second loop is ⅛ wavelength of the second frequency band. A length of the third loop is ⅛ wavelength of the third frequency band.

In an embodiment of the disclosure, the first frequency band is between 2400 MHz and 2500 MHz. The second frequency band is between 5000 MHz and 6500 MHz. The third frequency band is between 6500 MHz and 8000 MHz.

In an embodiment of the disclosure, the first electronic component includes an inductor. Each of the second electronic component, the third electronic component, the fourth electronic component, and the fifth electronic component includes a capacitor.

In an embodiment of the disclosure, the electronic device further includes a fifth radiator and a sixth electronic component. The fifth radiator is coupled to the first radiator. The sixth electronic component is coupled to the fifth radiator and the ground plane.

In an embodiment of the disclosure, the electronic device further includes a sixth radiator and a seventh electronic component. The sixth radiator is coupled to the first radiator. The seventh electronic component is coupled to the sixth radiator and the ground plane.

In an embodiment of the disclosure, each of the sixth electronic component and the seventh electronic component includes a capacitor.

Based on the above, the first electronic component of the electronic device of the disclosure is coupled to the feed end of the first radiator and the ground plane. The second electronic component is coupled to the first radiator and the second radiator. The third electronic component is coupled to the second radiator and the ground plane. The first electronic component, the first radiator, the second electronic component, the second radiator, and the third electronic component form the first loop. The first loop resonates at the first frequency band. The third radiator is coupled to the first radiator. The fourth electronic component is coupled to the third radiator and the ground plane. The first electronic component, the first radiator, the third radiator, and the fourth electronic component form the second loop. The second loop resonates at the second frequency band. The fourth radiator is coupled to the feed end. The fifth electronic component is coupled to the fourth radiator and the ground plane. The first electronic component, the feed end, the fourth radiator, and the fifth electronic component form the third loop. The third loop resonates at the third frequency band. Through the aforementioned design, the electronic device of the disclosure may form the antenna module with the loops and the frequency bands.

### BRIEF DESCRIPTION OF THE DRAWINGS

FIG. 1 is a schematic diagram of an electronic device according to an embodiment of the disclosure.

FIG. 2 is a partial enlarged view of FIG. 1.

FIG. 3A to FIG. 3C are schematic diagrams of a first loop, a second loop, and a third loop in FIG. 1.

FIG. 4 is a frequency-VSWR relationship diagram of the electronic device in FIG. 1.

FIG. 5 is a frequency-antenna efficiency relationship diagram of the electronic device in FIG. 1.

FIG. 6 is a schematic diagram of an electronic device according to another embodiment of the disclosure.

### DESCRIPTION OF THE EMBODIMENTS

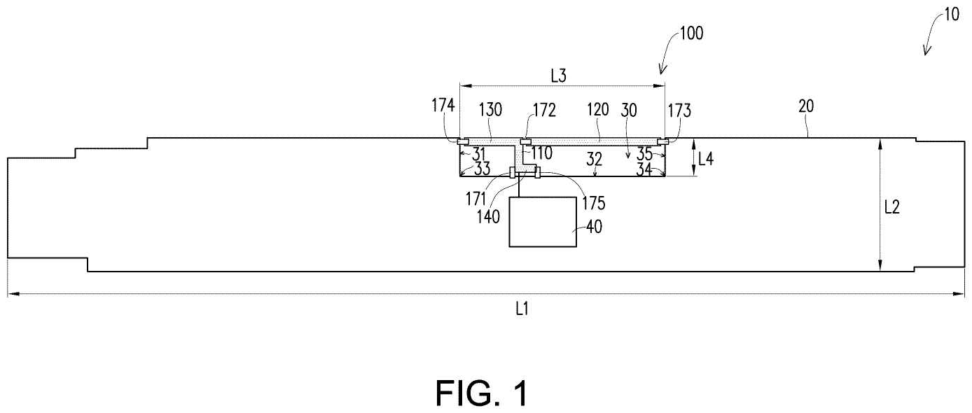

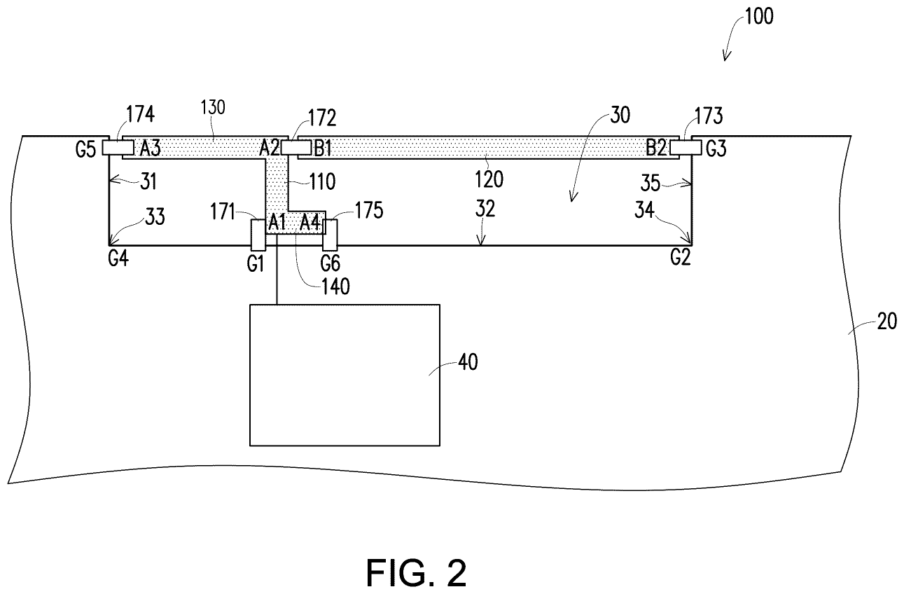

FIG. 1 is a schematic diagram of an electronic device according to an embodiment of the disclosure. FIG. 2 is a partial enlarged view of FIG. 1. Referring to FIG. 1 and FIG. 2, an electronic device 10 of this embodiment is, for example, a stylus. FIG. 1 shows, for example, a circuit board structure inside the stylus, but the type of the electronic device 10 is not limited thereto. The electronic device 10 includes a ground plane 20 and an antenna module 100. The ground plane 20 is, for example, a ground layer of a circuit board. In other embodiments, the ground plane 20 may also be a metal frame, and is not limited to the above.

The antenna module 100 is disposed within a recess 30 of the ground plane 20. The recess 30 includes a first edge 31 (positions G5 and G4 in FIG. 2), a second edge 32 (positions G4, G1, G6, and G2 in FIG. 2), and a third edge 35 (positions G2 and G3 in FIG. 2). In this embodiment, a length L1 of the ground plane 20 is, for example, 58.4 mm, a width L2 of the ground plane 20 is, for example, 8.9 mm, a length L3 of the recess 30 is, for example, 12.5 mm, and a width L4 of the recess 30 is, for example, 3 mm, but the aforementioned values are not limited thereto.

As shown in FIG. 2, the antenna module 100 includes a first radiator 110 (positions A1 and A2), a first electronic component 171, a second radiator 120 (positions B1 and B2), a second electronic component 172, a third electronic component 173, a third radiator 130 (positions A2 and A3), a fourth electronic component 174, a fourth radiator 140 (positions A1 and A4), and a fifth electronic component 175.

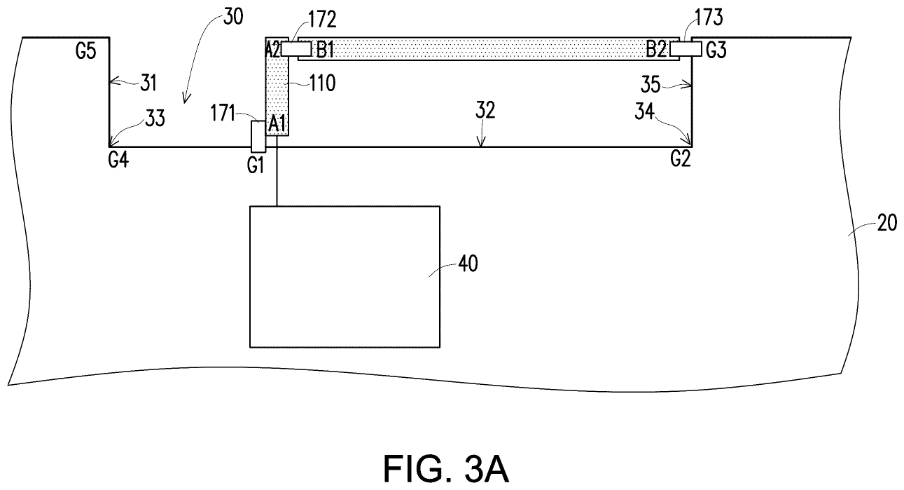

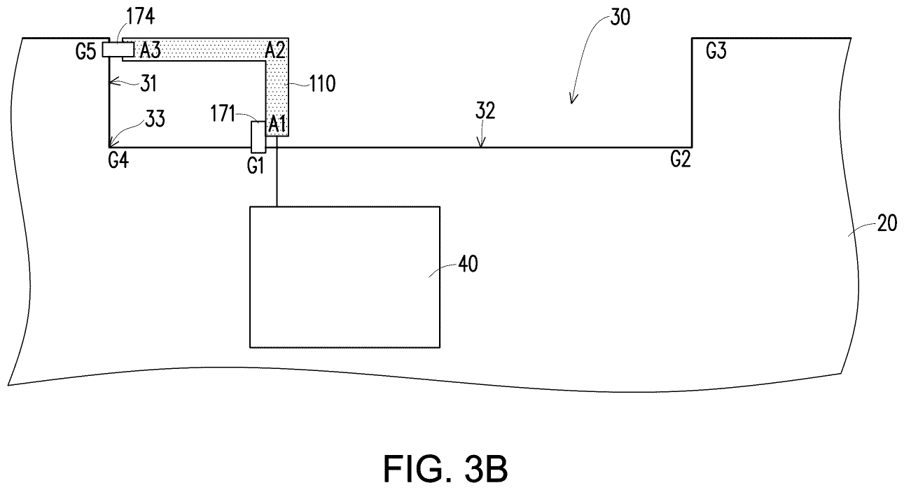

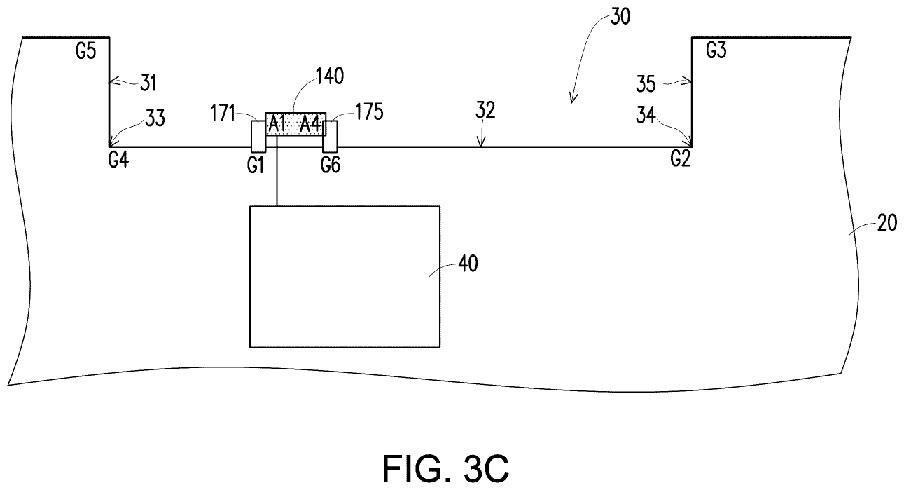

FIG. 3A to FIG. 3C are schematic diagrams of a first loop, a second loop, and a third loop in FIG. 1. Referring to FIG. 3A first, the first radiator 110 includes a feed end (the position A1). The feed end of the antenna module 100 is electrically coupled to a positive electrode of a signal source to receive signals from a chip 40. In addition, a negative electrode of the signal source is coupled to the system ground plane at positions G1, G3, G5, and G6 of the antenna module 100.

The first electronic component 171 is coupled to the feed end and the ground plane 20. In this embodiment, the first electronic component 171 is coupled to the second edge 32 of the recess 30, and the first edge 31 is closer to the first electronic component 171 than the third edge 35.

More specifically, there are a first position 33 and a second position 34 on the second edge 32. The first position 33 is coupled to the first edge 31. The second position 34 is coupled to the third edge 35. A distance between the first electronic component 171 and the first position 33 is 0.4 to 0.6 times a distance between the first electronic component 171 and the second position 34.

The second electronic component 172 is coupled to the first radiator 110 and the second radiator 120. The third electronic component 173 is coupled to the second radiator 120 and the third edge 35 of the ground plane 20.

In this embodiment, the first electronic component 171 includes an inductor. Each of the second electronic component 172 and the third electronic component 173 includes a capacitor. The inductance of the first electronic component 171 is between 1 nH and 1.5 nH, for example, 1.2 nH, but is not limited thereto. The capacitance of the second electronic component 172 is, for example, 180 pF, but is not limited thereto. The capacitance of the third electronic component 173 is, for example, between 0.2 pF and 0.4 pF, for example, 0.3 pF, but is not limited thereto.

In this embodiment, the first electronic component 171, the first radiator 110, the second electronic component 172, the second radiator 120, and the third electronic component 173 form a first loop. The first loop resonates at a first frequency band.

Specifically, in this embodiment, the first frequency band is between 2400 MHz and 2500 MHz. A length of the first loop is ⅛ wavelength of the first frequency band. Certainly, the range of the first frequency band and the length of the first loop are not limited thereto.

Referring to FIG. 3B, the third radiator 130 is coupled to the first radiator 110. The fourth electronic component 174 is coupled to the third radiator 130 and the first edge 31 of the ground plane 20. In this embodiment, the fourth electronic component 174 includes a capacitor. The capacitance of the fourth electronic component 174 is between 0.05 pF and 0.15 pF, for example, 0.1 pF, but is not limited thereto.

The first electronic component 171, the first radiator 110, the third radiator 130, and the fourth electronic component 174 form a second loop. The second loop resonates at a second frequency band. In this embodiment, the second frequency band is between 5000 MHz and 6500 MHz. A length of the second loop is ⅛ wavelength of the second frequency band. Certainly, the range of the second frequency band and the length of the second loop are not limited thereto. An effect of the aforementioned second electronic component 172 prevents the second loop from being affected by the first loop.

Referring to FIG. 3C, the fourth radiator 140 is coupled to the feed end. The fifth electronic component 175 is coupled to the fourth radiator 140 and the second edge 32 of the ground plane 20. In this embodiment, the fifth electronic component 175 includes a capacitor. The capacitance of the fifth electronic component 175 is, for example, between 0.1 pF and 0.3 pF, for example, 0.2 pF, but is not limited thereto.

The first electronic component 171, the feed end, the fourth radiator 140, and the fifth electronic component 175 form a third loop. The third loop resonates at a third frequency band. In this embodiment, the third frequency band is between 6500 MHz and 8000 MHz. A length of the third loop is ⅛ wavelength of the third frequency band. Certainly, the range of the third frequency band and the length of the third loop are not limited thereto.

The electronic device 10 of this embodiment integrates the aforementioned first, second, and third loops to form a multi-loop antenna architecture. The multi-loop antenna architecture has a characteristic of a full-plane miniaturized multi-frequency antenna design and may be adapted to any appearance design, including cylindrical, thin and flat, or rectangular column shapes. The electronic device 10 may be applied to the stylus and other wireless communication product devices (such as tablet computers and notebook computers).

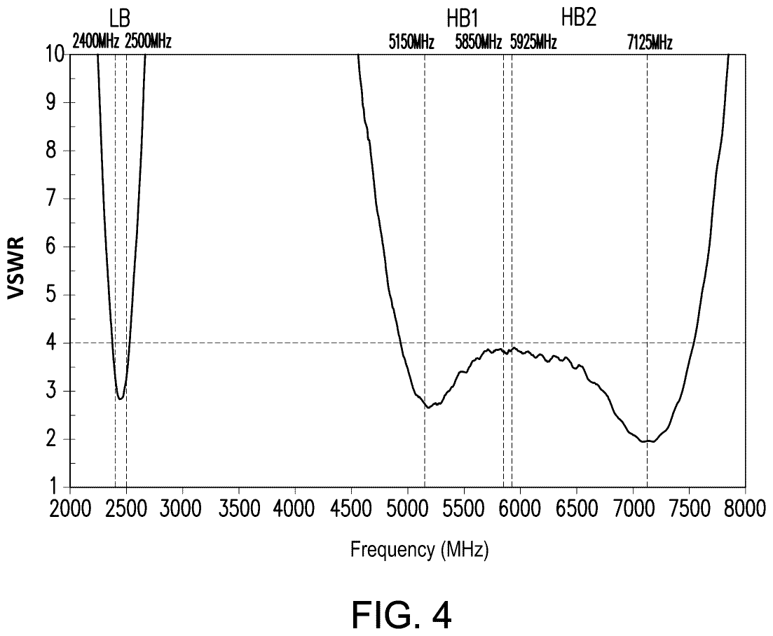

FIG. 4 is a frequency-VSWR relationship diagram of the electronic device in FIG. 1. Referring to FIG. 4, in this embodiment, with the limited size of the recess 30, which has the width L4 of only 3 mm, the electronic device 10 has good performance with the VSWR below 4 in both low frequency WiFi 2.4G and high frequency WiFi 5G/6E/7.

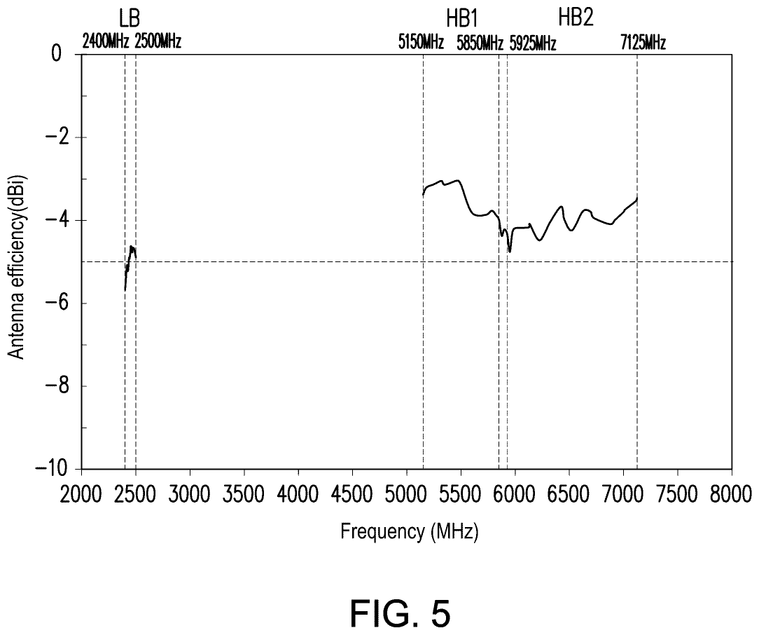

FIG. 5 is a frequency-antenna efficiency relationship diagram of the electronic device in FIG. 1. In this embodiment, referring to FIG. 5, the electronic device 10 has the antenna efficiency between −4.6 dBi and −5.7 dBi in low frequency WiFi 2.4G and the antenna efficiency between −3.0 dBi and −4.8dBi in high frequency WiFi 5G/6E/7, which demonstrates good antenna performance. That is, the electronic device 10 may have characteristics of broadband and good antenna efficiency in the extremely small space of the recess 30.

In addition, the electronic device 10 of this embodiment may use a MIMO multi-antenna architecture. As shown in FIG. 2, the antenna module 100 as the main antenna may be disposed near the tail end of the stylus m, and another antenna module 100 as an auxiliary antenna may be disposed near the tip end of the stylus. With a small size, the antenna module 100 may minimize an impact of hand gripping (body effect), meet a requirement of multi-antenna performance and enhance user experience.

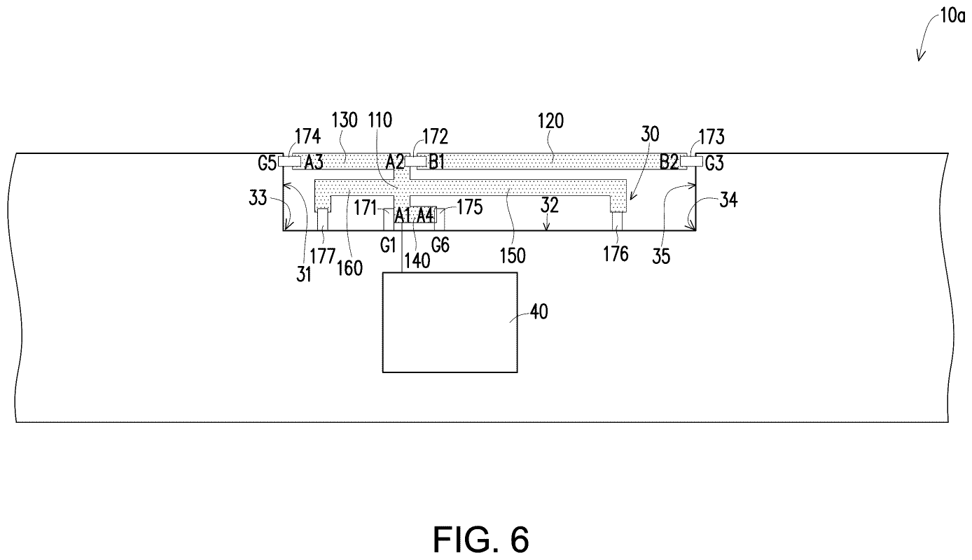

FIG. 6 is a schematic diagram of an electronic device according to another embodiment of the disclosure. Referring to FIG. 6, the main difference between an electronic device 10a in FIG. 6 and the electronic device 10 in FIG. 2 lies in that the electronic device 10a of this embodiment further includes a fifth radiator 150, a sixth electronic component 176, a sixth radiator 160, and a seventh electronic component 177.

The fifth radiator 150 is coupled to the first radiator 110. The sixth electronic component 176 is coupled between the fifth radiator 150 and the second edge 32 of the ground plane 20. The sixth radiator 160 is coupled to the first radiator 110. The seventh electronic component 177 is coupled between the sixth radiator 160 and the second edge 32 of the ground plane 20. In this embodiment, each of the sixth electronic component 176 and the seventh electronic component 177 includes a capacitor, but is not limited thereto.

In this embodiment, such design may broaden the antenna resonance frequency band and may be applied to 4G/5G antenna architecture. The frequency of 4G/5G antenna is approximately 800 MHz (frequency band is between 698 MHz and 960 MHz), and the third harmonic thereof is WiFi 2.4 GHz, so the size of the antenna is, for example, 3 times the size of WiFi 2.4 GHz. That is, the length and width of the recess 30 need to be enlarged by approximately 3 times, the recess 30 has a length of 37.5 mm and a width of 9 mm to accommodate a path in FIG. 6 to resonate the frequency band of 4G/5G. Certainly, to resonate at other frequency bands, a number of radiators and a number of electronic components may also be adjusted, and are not limited to the figure.

In summary, the first electronic component of the electronic device of the disclosure is coupled to the feed end of the first radiator and the ground plane. The second electronic component is coupled to the first radiator and the second radiator. The third electronic component is coupled to the second radiator and the ground plane. The first electronic component, the first radiator, the second electronic component, the second radiator, and the third electronic component form the first loop. The first loop resonates at the first frequency band. The third radiator is coupled to the first radiator. The fourth electronic component is coupled to the third radiator and the ground plane. The first electronic component, the first radiator, the third radiator, and the fourth electronic component form the second loop. The second loop resonates at the second frequency band. The fourth radiator is coupled to the feed end. The fifth electronic component is coupled to the fourth radiator and the ground plane. The first electronic component, the feed end, the fourth radiator, and the fifth electronic component form the third loop. The third loop resonates at the third frequency band. Through the aforementioned design, the electronic device of the disclosure may form the antenna module with multiple loops and multiple frequency bands.

What is claimed is:

1. An electronic device, comprising:
a ground plane, having a recess; and
an antenna module, disposed within the recess and comprising:
a first radiator, comprising a feed end;
a first electronic component, coupled to the feed end and the ground plane;
a second radiator;
a second electronic component, coupled to the first radiator and the second radiator;
a third electronic component, coupled to the second radiator and the ground plane, the first electronic component, the first radiator, the second electronic component, the second radiator, and the third electronic component forming a first loop, and the first loop resonating at a first frequency band;
a third radiator, coupled to the first radiator;
a fourth electronic component, coupled to the third radiator and the ground plane, the first electronic component, the first radiator, the third radiator, and the fourth electronic component forming a second loop, and the second loop resonating at a second frequency band;
a fourth radiator, coupled to the feed end; and
a fifth electronic component, coupled to the fourth radiator and the ground plane, the first electronic component, the feed end, the fourth radiator, and the fifth electronic component forming a third loop, and the third loop resonating at a third frequency band.

2. The electronic device according to claim 1, wherein the recess comprises a first edge, a second edge, and a third edge, the first electronic component is coupled to the second edge, and the first edge is closer to the first electronic component than the third edge.

3. The electronic device according to claim 2, wherein a first position and a second position are on the second edge, the first position is coupled to the first edge, the second position is coupled to the third edge, and a distance between the first electronic component and the first position is 0.4 to 0.6 times a distance between the first electronic component and the second position.

4. The electronic device according to claim 2, wherein the third electronic component is coupled to the third edge, the fourth electronic component is coupled to the first edge, and the fifth electronic component is coupled to the second edge.

5. The electronic device according to claim 1, wherein a length of the first loop is ⅛ wavelength of the first frequency band, a length of the second loop is ⅛ wavelength of the second frequency band, and a length of the third loop is ⅛ wavelength of the third frequency band.

6. The electronic device according to claim 1, wherein the first frequency band is between 2400 MHz and 2500 MHz, the second frequency band is between 5000 MHz and 6500 MHz, and the third frequency band is between 6500 MHz and 8000 MHz.

7. The electronic device according to claim 1, wherein the first electronic component comprises an inductor, and each of the second electronic component, the third electronic component, the fourth electronic component, and the fifth electronic component comprises a capacitor.

8. The electronic device according to claim 1, further comprising:
a fifth radiator, coupled to the first radiator; and
a sixth electronic component, coupled to the fifth radiator and the ground plane.

9. The electronic device according to claim 8, further comprising:
a sixth radiator, coupled to the first radiator; and
a seventh electronic component, coupled to the sixth radiator and the ground plane.

10. The electronic device according to claim 9, wherein each of the sixth electronic component and the seventh electronic component comprises a capacitor.
